(19) United States
(12) Patent Application Publication
(10) Pub. No.: US 2005/0037302 A1
(43) Pub. Date: Feb. 17, 2005

(54) System and method for starting a catalytic reactor

(76) Inventor: Michael Schonert, Munchen (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/487,017

(22) PCT Filed: Aug. 26, 2002
(86) PCT No.: PCT/EP02/09520

(30) Foreign Application Priority Data
Aug. 25, 2001 (DE) 10141776.4

(51) Int. Cl. F23L 15/00; F23N 5/00

(52) U.S. Cl. 431/11; 431/7; 431/75

(57) ABSTRACT

A system and method is provided for starting a catalytic reactor supplied with an oxygen-containing reactant gas, such as air, and a vaporized liquid fuel comprising carbon and hydrogen, such as methanol. The temperature difference between the temperature in the inlet area of the catalytic reactor and the temperature in the outlet area of the catalytic reactor is monitored, and the supply of the liquid fuel is adjusted based on the temperature difference, while the reactant gas is supplied to the catalytic reactor continuously.

### CROSS-REFERENCE TO RELATED APPLICATION

This application claims priority to German Application No. 101 41 776.4, filed Aug. 25, 2001, which priority application is incorporated herein by reference in its entirety.

### BACKGROUND OF THE INVENTION

1. Field of the Invention

The invention concerns a system and method for starting a catalytic reactor.

2. Description of the Related Art

During the low-temperature start-up of catalytic reactors, such as those used in a motor vehicle fuel cell system with a gas generation system, the reactants must be available in gaseous form.

Often, at least one of the reactants is a liquid under ambient conditions. The liquid reactant is atomized, such as by using a nozzle or a similar device, into a gaseous second reactant stream flowing into the catalytic reactor. In certain circumstances, for example at start-up, the liquid reactant is typically not evaporated entirely In the gaseous second reactant stream, since during startup of the reactor the stream is typically cold. Since the temperature of the catalytic reactor itself is far below the operating temperature, the evaporation can also not be completed in the catalytic reactor, before the reaction between the vaporized liquid reactant and the gaseous reactant takes place.

A severely disadvantageous result of this is that at least part of the reactant stream mixture enters the reactor in liquid form. If the reactor employs a porous catalyst support, then liquid reactant can accumulate in this catalyst support prior to its conversion in the reactor. When the catalytic reaction commences, then, as a result of accumulation of liquid reactant, the catalytic reaction takes place in the reactor at a far greater concentration of the liquid reactant than that intended (i.e. greater than the desired concentration of liquid reactant which was introduced into the gaseous reactant stream). This may be detrimental to the catalyst, since it can overheat in some areas due to the very high concentration of reactant.

Moreover, the presence of liquid reactant in the catalytic reactor can slow reactor start-up, as the presence of the liquid reactant in the catalyst support can block access of second reactant to the catalyst. This significantly impedes the start of the desired reaction.

Accordingly, there is a need for a system and method for starting a catalytic reactor operating on a vaporized liquid reactant, and for heating the reactor to the desired operating temperature (particularly from a low temperature), in as short a time as possible, whereby the emissions of unreacted reactants and by-products, and the degradation of the catalytic material are reduced.

### SUMMARY OF THE INVENTION

Using the present system and method, a catalytic reactor is started by supplying a liquid fuel, such as methanol, into a continuously circulated gaseous reactant stream, such as an air stream (which supplies the necessary oxygen), while monitoring the temperature in the area of both the reactor inlet and outlet. The liquid fuel is atomized in a feed line upstream of the catalytic reactor and is partially evaporated in the gaseous reactant stream. This results in cooling of the gaseous mixture, which can be detected by a drop in the reactor inlet temperature.

When the reactor is operational, the gaseous portion of the fuel reacts with the gaseous reactant, on the catalytically active surface of the catalytic reactor, which may for example have been applied as a coating onto a porous catalyst support.

Additional amounts of the liquid fuel can be evaporated using the thermal energy that is generated by the catalytic reaction and can subsequently be converted in the catalytic reactor.

If there is a reduction in the activity of the catalyst, or if there is an insufficient concentration of fuel, the gaseous mixture flows through the catalytic reactor without any significant amount of conversion taking place. If liquid fuel accumulates in the porous catalyst support due to capillary action, preventing the gaseous reactants from contacting the catalyst, the desired reaction will be inhibited and the catalyst support will cool to the temperature of the incoming mixture. This temperature drop will result in a drop in the reactor outlet temperature. Despite the continued supply of liquid fuel into the gaseous reactant stream, the catalytic reactor will not get started, since the temperature will continue to drop and the catalytic material becomes flooded with the liquid fuel. As this occurs, the reactor outlet temperature approaches the reactor inlet temperature.

In the present system and method, the temperature difference between the reactor inlet and the reactor outlet is monitored and, if the temperature in the reactor fails to increase, the supply of liquid fuel is reduced or shut off, while the gaseous reactant stream continues to be supplied to the reactor.

Subsequently, the catalyst support of the catalytic reactor will be heated slightly by the entering gaseous reactant stream, into which no, or a much smaller amount of, liquid fuel is being introduced. This allows the liquid fuel accumulated in the catalyst support to be at least partially evaporated by the thermal energy in the incoming gaseous reactant stream. Once the fuel is present in the reactor in gaseous form, it reacts with the reactive component of the gaseous reactant stream. As soon as the reaction commences in local areas of the catalyst support, the heat that is produced by that (exothermic) reaction spreads out, evaporating liquid fuel which has accumulated in the surrounding catalyst support. Eventually, the reaction propagates throughout the entire catalytic reactor.

The start of the reaction can be defected by means of an increase in the reactor outlet temperature. As soon as a specific reactor outlet temperature has been reached or the difference between the reactor outlet temperature and reactor inlet temperature has become sufficiently positive, the supply of liquid fuel can then be commenced or increased.

The evaporation of the accumulated liquid fuel into the gas stream should lead to a cooling of the catalytic reactor. If this cooling does not take place, i.e. if the temperature difference between the reactor inlet temperature and the reactor outlet temperature rises to zero or a value greater than zero, this is an indication that there is no remaining liquid fuel in the catalyst support that could evaporate. This state can also be used to trigger starting or increasing the supply of liquid fuel into the gaseous reactant stream, so that the described sequence can start from the beginning.

The entire process can be repeated as often as is necessary to achieve a successful start-up of the catalytic reactor.

The advantage of the present system and method is that it can be implemented very easily. The temperature difference is dependent on the amount of liquid fuel supplied and evaporated (because of the cooling which occurs as a result of the evaporation of the fuel into the gaseous reactant stream) and on the reaction of the mixture in the catalytic reactor, which generates heat. The supply of liquid fuel into the gaseous reactant stream is adjusted based on the monitored temperature difference. The apparatus required is very simple, as only one additional temperature sensor is required.

The continuous supply and circulation of the gaseous reactant stream through the reactor, which leads to unreacted liquid fuel being discharged from the catalytic reactor, can reduce catalyst degradation since there will not be excessively high local concentrations of the fuel and less tendency for local overheating to occur.

If the reactants used are air and a liquid fuel that contains carbon and hydrogen, then this reduction in locally excessive concentrations of liquid fuel will prevent, or at least reduce, hydrocarbon and carbon monoxide emissions which would be the result of a local combustion with a lambda value of λ<1, i.e. fuel excess.

As a further advantage, the present system and method offers significant time saving in the start-up of such a catalytic reactor when compared to sequence that includes aborting the start-up procedure, followed by a complete purging of the system, and a re-start.

These and other aspects will be evident upon reference to the attached Figures and following detailed description.

### BRIEF DESCRIPTION OF THE DRAWING(S)

FIG. 1 shows one embodiment of a system for implementing the present method.

FIG. 2 shows another embodiment of a system for implementing the present method.

### DETAILED DESCRIPTION OF THE INVENTION

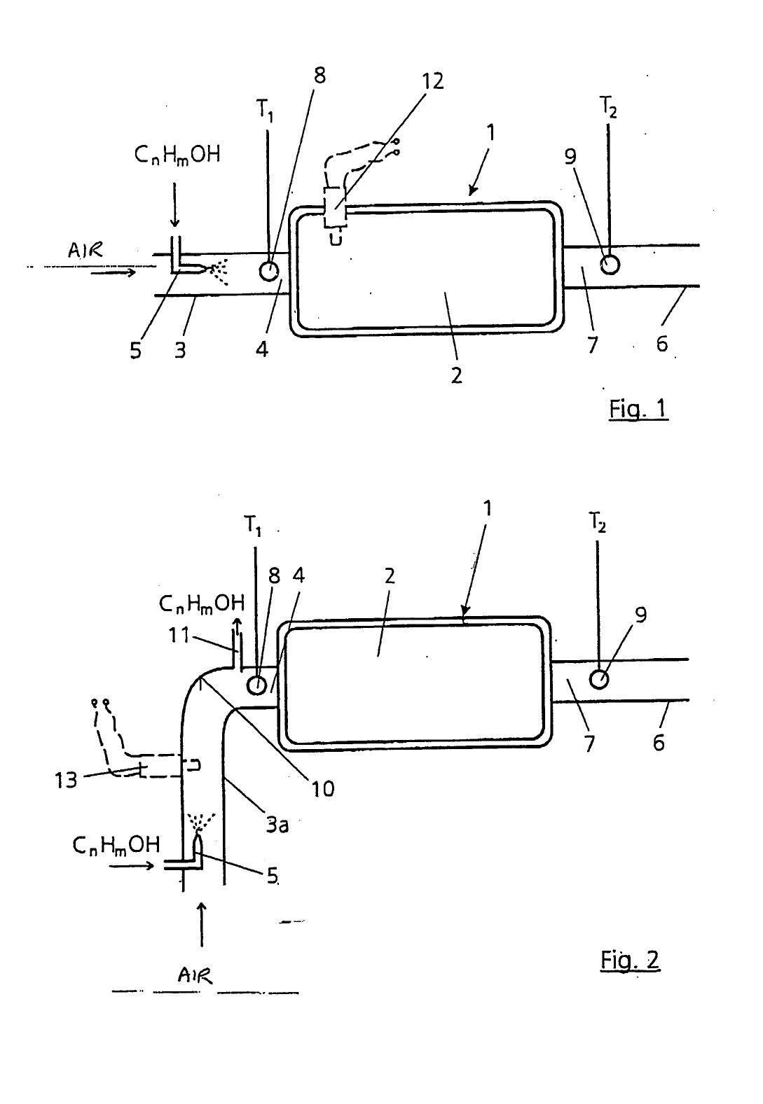

FIG. 1 depicts a catalytic reactor 1 with a catalyst support 2, which for example may consist of a porous material coated with catalyst, a bed of pellets that are coated with catalyst, a structure that is similar to a plate reactor, or the like.

An oxygen-containing gas stream, e.g. an air stream, reaches reactor inlet 4 of the catalytic reactor 1 through inlet pipe 3. Inlet pipe 3 contains an atomizer 5, which can introduce a liquid fuel, such as a hydrocarbon derivative CnHmOH, into the air stream. The liquid fuel, for example methanol, is atomized in the air stream and consequently can at least partially evaporate in the air stream.

Subsequently, the mixture of methanol and air reaches the catalyst support 2, where it is reacts under the required operating conditions, such as temperature, etc., after which it can be discharged from the catalytic reactor 1 through outlet pipe 6, which is connected to reactor outlet 7.

Catalytic reactor 1 may, for example, be part of a gas generation system or an exhaust gas utilization system in a fuel cell system, such as a fuel cell system that is used in a motor vehicle to generate the energy required for propulsion. During start-up of this type of reactor, all the components of catalytic reactor 1, as well as the reactants, will be at a comparatively low temperature, such as the ambient temperature of the vehicle in which the system is employed.

Catalytic reactor 1 is started by supplying liquid methanol into the air stream by means of atomizer 5. A portion of the methanol that is atomized will evaporate in the air stream. The mixture will pass a temperature sensor 8 disposed near reactor inlet 4, which monitors the temperature T₁ in the area of reactor inlet 4. The monitoring of T₁ makes it possible to detect that the supply of methanol is taking place, since the methanol is evaporated in the air stream, which reduces T₁ compared with the situation where no methanol is being supplied. Thus, monitoring only T₁ allows the supply of methanol by atomizer 5 to be monitored.

The methanol, which now is at least partially present in gaseous form, can be reacted, together with the oxygen in the air stream, at the catalytically active surface of catalyst support 2.

If there is an insufficient concentration of methanol in the methanol-air mixture, the catalytic reactor does not start, i.e. no reaction takes place. Consequently, no thermal energy is generated due to the lack of reaction, and catalytic reactor 1 will subsequently cool to the temperature of the methanol-air mixture. This situation can be detected by means of a further temperature sensor 9 disposed near reactor outlet 7, which monitors the temperature T₂ in the area of reactor outlet 7. The lack of reaction can be detected by a drop in T₂.

Similarly, if the catalyst becomes flooded with liquid methanol, the reactor will not get started, despite the continued dosing of methanol into the air stream by means of atomizer 5. The lack of catalytic conversion can cause the liquid methanol to spread in the generally porous catalyst support 2, particularly due to capillary action, and to flood the catalytic material, excluding the oxygen. Due to the lack of combustion, T₂ (i.e. at reactor outlet 7) approaches T₁ (i.e. at reactor inlet 4).

In the situation where a significant temperature increase is not present, i.e. if the monitored temperature difference between reactor inlet 4 and reactor outlet 7 (T₂-T₁) is not positive, this is used to trigger a reducing or stopping the supply of methanol to catalytic reactor 1.

At the same time, the air stream continues to flow through catalytic reactor 1. Thus, the entering air stream will slowly heat up due to the lack of evaporation of supplied methanol, and the liquid methanol that had accumulated in catalyst support 2 will subsequently evaporate into the entering air stream, and can then react with the oxygen in the air stream. Once the catalytic conversion has started, the reaction spreads to surrounding areas of the catalyst support 2 due to the thermal energy being generated by the reaction and the resulting accelerated evaporation of liquid methanol in other local areas of catalyst support 2. The start of this reaction can be detected by an increase in T₂ at the reactor outlet 7, i.e. a positive temperature difference T₂-T₁. Once T₂ has reached a predetermined value, the supply of methanol can be resumed or increased; catalytic reactor 1 has then been started.

If catalytic reactor 1 cools again due to the supply and accumulation of liquid methanol, the described sequence is repeated, and the methanol dosing potentially has to be reduced or shut off again. This process may be repeated until catalytic reactor 1 has successfully been started and warmed up.

In an alternative embodiment, the controlled supply of methanol can be implemented by conducting appropriate experimental trials prior to mass production of catalytic reactor 1 to empirically determine the amount of time for which the supply of methanol should be stopped or reduced. This determined time period may be stored and used to establish when the supply of methanol is to be restarted, eliminating the need for the corresponding monitoring or control processes, which further reduces the complexity of the present system and method with respect to control circuitry.

FIG. 2 shows another embodiment of the present system and method, whereby a first pipe fitting 3a is included, consisting of a turn of at least approximately 90° upstream of reactor inlet 4. This offers the advantage that in the area of the turn liquid methanol is forced against wall 10 of first pipe fitting 3a due to centrifugal force, where it accumulates in liquid form. This accumulating liquid methanol can be carried off through a second pipe fitting 11. Of course, one skilled in the art can also envision installing other elements to separate liquid methanol from the inlet gas stream, either in addition or as an alternative, in the area of inlet pipe 3, for example drip catchers in the form of wire fabrics or similar devices.

Except as outlined above, the mode of operation of the embodiment illustrated in FIG. 2 is comparable to the mode of operation of the embodiment illustrated in FIG. 1.

The illustrations for the two embodiment examples depict an optional heater 12 or 13. This heater may be an electrical heater such as a heater coil, a glow plug, or similar device, and can be arranged in catalytic reactor 1 itself, as schematically indicated by heater 12 in FIG. 1. In the embodiment of FIG. 2, heater 13 is situated in the area of first fitting 3a, where it improves the evaporation of the methanol supplied to first pipe fitting 3a, so that the above-described method of starting catalytic reactor 1 can be supported by additional heating.

Due to their heat input, heaters 12, 13 make it possible to start—at least locally—a reaction in the area of catalytic reactor 1, either while the supply of methanol is taking place or during a break in the supply, so that the reaction can spread throughout the entirety of catalytic reactor 1.

In such a procedure, the thermal energy introduced by heaters 12, 13 has to be taken into account when calculating the temperature difference T₂-T₁. If heater 12 is used to increase the temperature of catalytic reactor 1, then it is sufficient to subtract from T₂ (i.e. the temperature at reactor outlet 7) the temperature that corresponds to the introduced thermal energy. If the thermal energy is introduced in the area of inlet pipe 3 or first pipe fitting 3a, then the thermal energy must be taken into account in determining the overall temperature difference T₂-T₁ or in determining T₁ (i.e. the temperature at reactor inlet 4).

Similarly, if several heaters 12, 13 are employed at various positions, a suitable correction must be applied to the temperatures T₂-T₁ or to the threshold value that is used for switching the supply of methanol on or off.

1. A method of starting a catalytic reactor, comprising:
supplying the reactor with a reactant gas stream comprising oxygen and an atomized liquid fuel,
determining a temperature difference between a reactor inlet temperature and a reactor outlet temperature, and
adjusting the supply of the liquid fuel based on the temperature difference.

2. The method of claim 1, wherein the reactant gas is air.

3. The method of claim 1, wherein the liquid fuel comprises a hydrocarbon.

4. The method of claim 1, wherein the supply of liquid fuel is stopped when the reactor outlet temperature is less than the reactor inlet temperature.

5. The method of claim 4, further comprising restarting the supply of the liquid fuel once the reactor outlet temperature is greater than the reactor inlet temperature.

6. The method of claim 4, further comprising restarting the supply of the liquid fuel after a predetermined period.

7. The method of claim 1, further comprising introducing thermal energy into the reactor, and wherein the reactor outlet temperature used in determining the temperature difference is adjusted to account for the temperature increase resulting from the introduction of the thermal energy.

8. The method of claim 1, further comprising introducing thermal energy into the gas upstream of the reactor, and wherein the determined temperature difference takes into account the temperature increase resulting from the introduction of thermal energy.

9. The method of claim 1, wherein the reactor is a component of a fuel cell system.

10. The method of claim 9, wherein the fuel cell system is a component of a motor vehicle.

11. A system for starting a catalytic reactor comprising:
a gas supply passage configured to supply a gas stream to an inlet port of the reactor,
a liquid fuel supply passage comprising an atomizer to introduce an atomized liquid fuel into the gas supply passage;
an outlet passage for directing fluid from an outlet port of the reactor, at least one temperature sensor disposed adjacent to each of the inlet and the outlet ports, and
a control valve disposed in the liquid fuel supply passage and couple to receive an input signal from the temperature sensors.

12. The system of claim 11, further comprising a heater.

13. The system of claim 12, wherein the heater is disposed in the gas supply passage.

14. The system of claim 12, wherein the heater is disposed in the reactor.

15. The system of claim 11, wherein the gas supply passage comprises a turn of approximately 90° upstream of the inlet port, and an accumulated liquid fuel removal passage disposed adjacent to the turn.

16. The system of claim 11, wherein the system is a component of a fuel cell system for a motor vehicle.
